(19) United States
(12) Patent Application Publication
(10) Pub. No.: US 2017/0119496 A1
(43) Pub. Date: May 4, 2017

(54) Dental Tool Control System

(71) Applicant: Akei Griffin, Roselle, NJ (US)

(72) Inventor: Akei Griffin, Roselle, NJ (US)

(21) Appl. No.: 14/927,100

(22) Filed: Oct. 29, 2015

(51) Int. Cl. A61C 1/00; A61G 15/00

(52) U.S. Cl. CPC A61C 1/0023; A61G 15/00

(57) ABSTRACT

A dental tool control system includes a chair that may be positioned in a dental environment. A port is coupled to the chair and the port may be electrically coupled to a power tool. A control is positioned proximate the chair and the control may be manipulated. The control is in wireless communication with the port and the control may control operational parameters of the power tool.

### BACKGROUND OF THE DISCLOSURE

### Field of the Disclosure

The disclosure relates to control devices and more particularly pertains to a new control device for facilitating wireless control of a dental tool.

### SUMMARY OF THE DISCLOSURE

An embodiment of the disclosure meets the needs presented above by generally comprising a chair that may be positioned in a dental environment. A port is coupled to the chair and the port may be electrically coupled to a power tool. A control is positioned proximate the chair and the control may be manipulated. The control is in wireless communication with the port and the control may control operational parameters of the power tool.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a dental tool control system according to an embodiment of the disclosure.

FIG. 2 is a top phantom view of an embodiment of the disclosure.

FIG. 3 is a bottom view of an embodiment of the disclosure.

FIG. 4 is a perspective in-use view of an embodiment of the disclosure.

FIG. 5 is a schematic view of an embodiment of the disclosure.

### DESCRIPTION OF THE PREFERRED EMBODIMENT

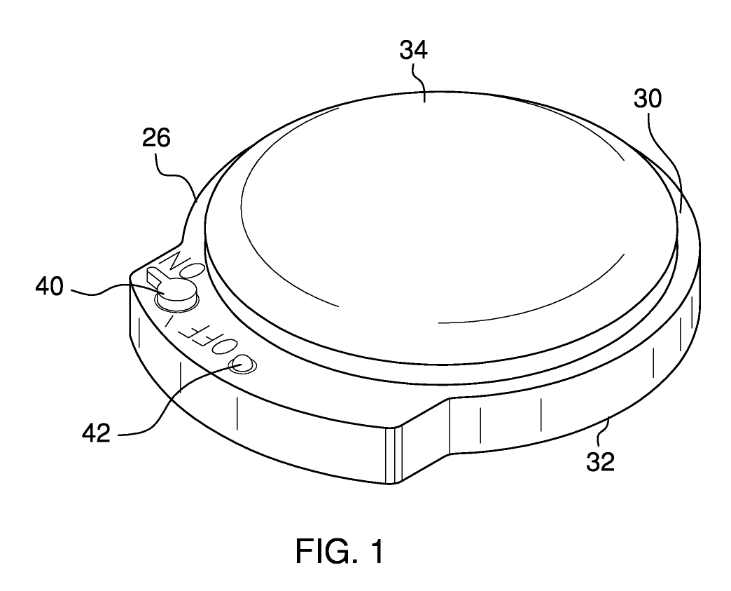

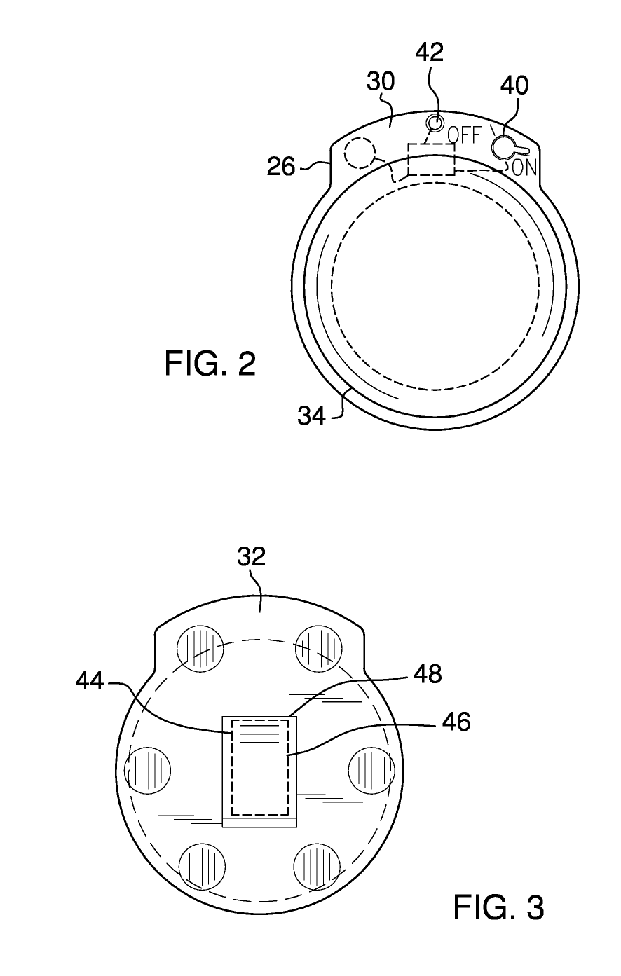

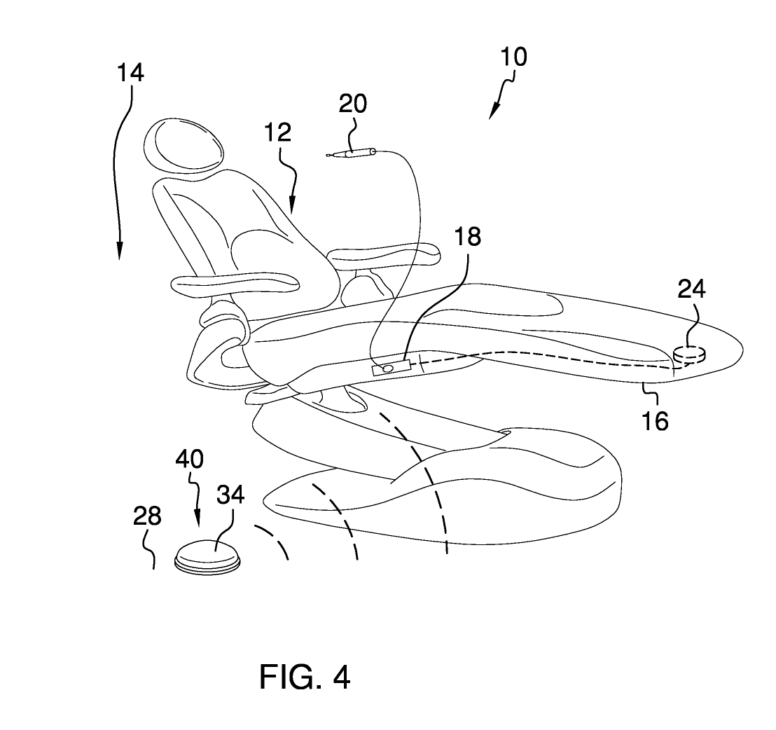

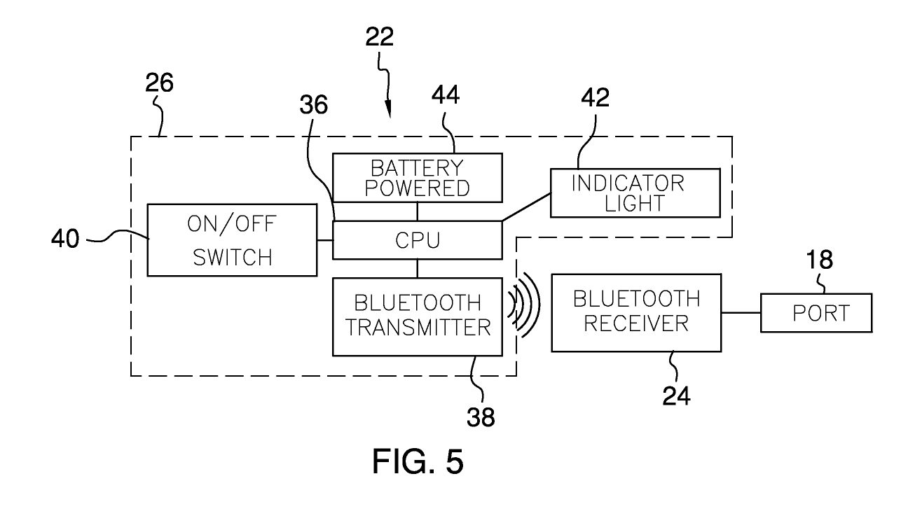

With reference now to the drawings, and in particular to FIGS. 1 through 5 thereof, a new control device embodying the principles and concepts of an embodiment of the disclosure and generally designated by the reference numeral 10 will be described.

As best illustrated in FIGS. 1 through 5, the dental tool control system 10 generally comprises a chair 12 that may be positioned in a dental environment 14. The chair 12 may comprise a dental chair or the like and the chair 12 has a bottom side 16. A port 18 is coupled to the chair 12 and the port 18 may be electrically coupled to a power tool 20. The power tool 20 may comprise any power tool utilized in the convention of dentistry. The port 18 may insertably receive a conductor that is electrically coupled to the power tool 20.

A control 22 is positioned proximate the chair 12 and the control 22 may be manipulated. The control 22 is in communication with the port 18 and the control 22 may control operational parameters of the power tool 20. The control 22 comprises a receiver 24 that is coupled to the chair 12. The receiver 24 is electrically coupled to the port 18 and the chair 12. The receiver 24 may comprise a radio frequency receiver or the like. The receiver 24 may utilize a WPAN signal and the WPAN signal may be a Bluetooth signal.

A foot pedal 26 is provided and the foot pedal 26 may be positioned on a support surface 28. The support surface 28 may comprise a floor or the like the foot pedal 26 may be positioned proximate the chair 12. The foot pedal 26 may be stepped upon and the foot pedal 26 has a top side 30 and a bottom side 32. The foot pedal 26 includes a button 34 that is movably coupled to the top side 30. Thus, the button 34 may be manipulated. The button 34 may comprise a pressure sensitive button or the like. Thus, the button 34 may be manipulated with a minimum pressure and a maximum pressure.

A processor 36 is positioned within the foot pedal 26 and the processor 36 is electrically coupled to the button 34. The processor 36 may comprise an electronic processor or the like. The processor 36 converts the pressure imparted onto the button 34 into a signal that has a signal strength corresponding to the pressure imparted onto the button 34. Thus, the button 34 acts as a rheostat.

A transmitter 38 is positioned within the foot pedal 26 and the transmitter 38 is electrically coupled to the processor 36. The transmitter 38 is in electrical communication with the receiver 24. Thus, the button 34 turns the power tool 20 on and off. Additionally, the button 34 actuates the power tool 20 between a minimum speed and a maximum speed corresponding to the processor's 36 signal strength. The transmitter 38 may comprise a radio frequency transmitter or the like. The transmitter 38 may utilize a WPAN signal or the like and the WPAN signal may be a Bluetooth signal.

A switch 40 is coupled to the foot pedal 26. The switch 40 may be positioned on the top side 30 and the switch 40 may be manipulated. The switch 40 is electrically coupled to the processor 36 such that the switch 40 turns the processor 36 on and off. A light emitter 42 is coupled to the foot pedal 26 and the light emitter 42 is electrically coupled to the switch 40. The light emitter 42 emits light when the processor 36 is turned on. The light emitter 42 may comprise an LED or the like and the light emitter 42 may be positioned on the top side 30.

A power supply 44 is positioned within the foot pedal 26 and the power supply 44 is electrically coupled to the processor 36. The power supply 44 comprises at least one battery 46. A battery cover 48 is removably coupled to the bottom side 32 of the foot pedal 26. The power supply 44 is positioned beneath the battery cover 48. A plurality of feet 50 is coupled to the bottom side 32 of the foot pedal 26. The feet 50 are spaced apart from each other and distributed on the bottom side 32. Each of the feet 50 may abut the support surface 28.

In use, the power tool 20 is electrically coupled to the port 18. The switch 40 is manipulated to turn the processor 36 on. The button 34 is stepped on with a selected amount of pressure. Thus, the power tool 20 is actuated to a selected speed. The wireless communication between the foot pedal 26 and the port 18 eliminates the need for a conductor to extend between the foot pedal 26 and the port 18. Thus, the foot pedal 26 enhances cleanliness of the dental environment. Additionally, the wireless communication eliminates a tripping hazard associated with the conductor extending between the foot pedal 26 and the port 18.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dental tool control system comprising:
a chair being configured to be positioned in a dental environment;
a port being coupled to said chair, said port being configured to be electrically coupled to a power tool; and
a control being positioned proximate said chair wherein said control is configured to be manipulated, said control being in wireless communication with said port wherein said control is configured to control operational parameters of the power tool.

2. The system according to claim 1, wherein said control comprises a receiver being coupled to said chair, said receiver being electrically coupled to said port.

3. The system according to claim 1, wherein said control comprises a foot pedal being configured to be positioned on a support surface wherein said foot pedal is configured to be stepped upon, said foot pedal having a top side.

4. The system according to claim 3, wherein said foot pedal includes a button being movably coupled to said top side wherein said button is configured to be manipulated.

5. The system according to claim 4, further comprising:
a receiver being coupled to said chair, said receiver being electrically coupled to said port;
a processor being positioned within said foot pedal, said processor being electrically coupled to said button; and
a transmitter being positioned within said foot pedal, said transmitter being electrically coupled to said processor, said transmitter being in electrical communication with said receiver wherein said button is configured to turn the tool on and off.

6. The system according to claim 5, further comprising a switch being coupled to said foot pedal wherein said switch is configured to be manipulated, said switch being electrically coupled to said processor such that said switch turns said processor on and off.

7. The system according to claim 5, further comprising a power supply being positioned within said foot pedal, said power supply being electrically coupled to said processor, said power supply comprising at least one battery.

8. A dental tool control system comprising:
a chair being configured to be positioned in a dental environment, said chair having a bottom side;
a port being coupled to said chair, said port being configured to be electrically coupled to a power tool; and
a control being positioned proximate said chair wherein said control is configured to be manipulated, said control being in wireless communication with said port wherein said control is configured to control operational parameters of the power tool, said control comprising:
a receiver being coupled to said chair, said receiver being electrically coupled to said port, and
a foot pedal being configured to be positioned on a support surface wherein said foot pedal is configured to be stepped upon, said foot pedal having a top side, said foot pedal including:
a button being movably coupled to said top side wherein said button is configured to be manipulated,
a processor being positioned within said foot pedal, said processor being electrically coupled to said button,
a transmitter being positioned within said foot pedal, said transmitter being electrically coupled to said processor, said transmitter being in electrical communication with said receiver wherein said button is configured to turn the tool on and off,
a switch being coupled to said foot pedal wherein said switch is configured to be manipulated, said switch being electrically coupled to said processor such that said switch turns said processor on and off, and
a power supply being positioned within said foot pedal, said power supply being electrically coupled to said processor, said power supply comprising at least one battery.
